(19) United States
(12) Patent Application Publication
(10) Pub. No.: US 2006/0046570 A1
(43) Pub. Date: Mar. 2, 2006

(54) Connector for capacitor microphone and method of shielding the same

(75) Inventor: Hiroshi Akino, Machida-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Audio-Technica, Machida-shi (JP)

(21) Appl. No.: 11/195,740

(22) Filed: Aug. 3, 2005

(30) Foreign Application Priority Data
Aug. 26, 2004 (JP) 2004-246455

(51) Int. Cl. H01R 9/03

(52) U.S. Cl. 439/610

(57) ABSTRACT

A capacitor microphone connector comprises a crimp. In the connector, the crimp is made of a shielding material, includes a thick cylindrical part and a thin cylindrical part; the thin cylindrical part is fitted around a folded part of a shielded wire of a microphone cable, and the crimp is joined to the microphone cable; the thick cylindrical part extends over a joint of the connector and microphone cable; and the thick cylindrical part is fitted into a connector housing.

### CROSS REFERENCE TO RELATED APPLICATIONS

This application is based upon and claims the benefit of priority from prior Japanese Patent Application No. 2004-246455 filed on Aug. 26, 2004; the entire contents of which are incorporated by reference herein.

### BACKGROUND OF THE INVENTION

1. Field of the Invention

This invention relates to a connector for a capacitor microphone, a structure for shielding the connector, and a shielding method thereof.

2. Description of the Related Art

Usually, a capacitor microphone has a high impedance in a microphone unit, and includes an impedance converter constituted by a field effect transistor (FET).

With a tiepin or gooseneck type microphone, a microphone unit itself houses an impedance converter therein in order to make the microphone less visible. Further, a low-cut circuit and an output circuit are housed in a separate circuit housing, and a dedicated microphone cable is used to connect the microphone unit and the circuit housing. The microphone unit converts voices into electric audio signals, which are transmitted to the circuit housing, and are output from the output circuit. Such a circuit housing is called a “power module”.

The dedicated microphone cable connecting the microphone unit and the power module is a 2-conductor shielded cable, and includes a power wire supplying power to the microphone, a signal wire inputting the audio signals to the power module, and a shielded wire which electrostatically shields the power wire and signal wire.

The audio signal is transmitted in an unbalanced state through the microphone cable, and suffers from poor immunity to external noise, i.e., is adversely affected by external electromagnetic waves. Specifically, external electromagnetic waves arriving at the microphone cable enter into the microphone unit or power module, are detected by a semiconductor device composing the microphone unit or power module, and are mixed in the audio signal as noise.

A microphone output is supplied from the power module via a balanced and shielded cable. When strong electromagnetic waves are applied to the microphone or the output cable of the microphone, a high frequency current runs through a microphone connector and gets into the microphone, where the high frequency current is demodulated by the impedance converter, and is outputted as audio frequency noise via the microphone.

The microphone cable is attachable to and detachable from the microphone using a 3-pin microphone connector (e.g., EIAJ RC-5236, “Circular connectors, latch lock type for audio equipment”). With the 3-pin microphone connector, usually No. 1 pin is used for grounding, No. 2 pin is for a hot side of a signal, and No. 3 is for a cold side of the signal.

A connector is attached to an ordinary microphone cable as follows. Male and female parts of the connector are directly soldered to a conductor and a shielded wire of the microphone cable. By the way, the male and female parts are in contact with each other. No. 1 pin of the connector is connected to a metal connector housing using a lead wire. There is an impedance to high frequency waves between the shielded wire of the microphone cable and the connector housing, so that a high frequency current gets into the microphone.

FIG. 4(A) to FIG. 4(C) of the accompanying drawings show a connector for a dedicated microphone cable of the related art. Referring to these drawings, a female connector 10 is inserted into a male connector of a microphone, so that the female and male connectors are electrically connected. The female connector 10 is a so-called 3-pin type, includes three pins which are engageable with the male connector of the microphone, and terminal blocks which are electrically integral with the three pins, and extend outward from a rear end of the connector 10. Ends of conductors 23 and 24 and shielded wire 22 of the microphone cable 20 are soldered to the terminal blocks. An insulating sleeve 60 covers an outer surface of the microphone cable 20, a crimp 70 is attached behind the insulating sleeve 60, and a bush 40 is attached around the microphone cable 20.

The insulating sleeve 60 surrounds a joint of one end of the microphone cable 20 and the connector 10, and protects the joint against short-circuiting. The insulating sleeve 60 has an outer diameter substantially equal to an outer diameter of the connector 10. The crimp 70 includes a cylindrical part 71, and a plurality of claws 72. The cylindrical part 71 extends over an insulating cover on the microphone cable 20 and the connector 10 with a spatial allowance. The claws 72 crimp the insulating cover, thereby making the microphone cable 20 and the connector 10 integral. The bush 40 includes a tapered end 41 whose outer diameter is slightly larger than that of the microphone cable 20, and a cover 42 which extends over the crimp 70 and is thicker than the tapered end 41.

The connector 10 is fitted into a cylindrical connector housing 50, which is long enough to house the connector 10, the insulating sleeve 60 and the cylindrical part 71 of the crimp 70. The connector housing 50 has its rear ends engaged into a front end of the bush 40.

FIG. 4(A) to FIG. 4(C) show how the connector for a microphone cable is assembled. Specifically, FIG. 4(C) shows the assembled connector. Referring to FIG. 4(A), the conductors of the microphone cable 20 are soldered to terminal blocks of the connector 10. Before or after soldering, the insulating sleeve 60 and the crimp 70 are let over the microphone cable 20. A front end of the insulating sleeve 60 is brought into contact with a rear end of the connector 10, and a front end of the cylindrical part 71 of the crimp 70 is brought into contact with a rear end of the insulating sleeve 60. Thereafter, the claws 72 of the crimp 70 are pressed, thereby coupling the crimp 70 to the microphone cable 20, as shown in FIG. 4(B). The rear end of the connector housing 50 attached over the cylindrical part 71 of the crimp 70 is fitted into the front end of the bush 40, thereby integrating the connector housing 50 and the bush 40. Hence, the connector for a microphone cable is made integral with the connector 10 by means of the insulating sleeve 60 and the crimp 70. Refer to FIG. 4(C).

In the example shown in FIG. 4(A) to FIG. 4(C), the shielded wire 22 connected to the crimp 70 (fixing the microphone cable 20) is brought into contact with the inner surface of the connector housing 50, thereby shielding the connector 10. However, the insulating sleeve 60 and the crimp 70 stand between the connector housing 50 and the microphone cable 20, so that the connector housing 50 and the shielded wire of the microphone cable 20 are electrically discontinuous. There is a problem that the electrically discontinuous part serves as an opening through which external high frequency electric waves arrive.

In order to overcome the foregoing problem, a microphone cable shielding structure has been proposed as shown in FIG. 5. A shielded wire extending over conductors of a microphone cable 20 is folded outward at one end of the microphone cable 20, and is put on a sheath of the microphone cable 20. Then, a thin cylindrical part 81 of a crimp 80 is put over a folded part 21 of the shielded wire, and is crimped, thereby electrically connecting the crimp 80 and the shielded wire. Further, the crimp 80 is pressed to the microphone cable 20. The crimp 80 has a flange 82 at a front end of the cylindrical part 80. The flange 82 is as thick as the rear end of the connector housing 50, and is brought into contact with the rear end of the connector housing 50, thereby electrically connecting the crimp 80 and the connector housing 50.

In the example shown in FIG. 5, the connector housing 50 and the crimp 80 are electrically connected in order to enhance shielding, compared with the example shown in FIG. 4() to FIG. 4(C). However, the connector housing 50 and the crimp 80 are simply in point contact with each other, so that sufficient shielding effect cannot be accomplished.

Up to now, proposals have been made in order to cover microphone bodies with cylindrical shields as disclosed in Japanese Patent Laid-Open Publications No. 2002-152,892 and Hei 11-155,198. No special emphasis has been placed on shielding of connectors as described above. Therefore, high frequency electromagnetic waves tend to enter into the connector, which causes noise to be mixed into audio signals.

At present, as cellular phones become very popular, high frequency electromagnetic waves brim over anywhere, and high frequency signals tend to enter into a microphone cable via a connector, thereby causing noise in audio signals. Especially, a capacitor microphone is easily affected by high frequency signals from a near cellular phone, and is susceptible to noise caused by high frequency signals.

The present invention is aimed to overcoming problems of the related art, and providing not only a connector which is applicable to a capacitor microphone, reliably blocks external high frequency signals, and prevents them from mixing into audio signals which are converted by the microphone into electric signals, but also to a method of shielding the microphone cable and connector.

### SUMMARY OF THE INVENTION

A capacitor microphone connector comprises a crimp, wherein the crimp is made of a shielding material, includes a thick cylindrical part and a thin cylindrical part; the thin cylindrical part is crimped around a folded part of a shielded wire of a microphone cable, and the crimp is joined to the microphone cable; the thick cylindrical part extends over a joint of the connector and microphone cable; and the thick cylindrical part is fitted into a connector housing.

### BRIEF DESCRIPTION OF THE DRAWINGS

FIG. 1(A), FIG. 1(B) and FIG. 1(C) are cross sections of a connector for a capacitor microphone, showing how the connector and capacitor microphone are assembled;

FIG. 2 is an enlarged cross section of the assembled connector;

FIG. 3 is a cross section of a modified example of a crimp used in the connector;

FIG. 4(A), FIG. 4(B) and FIG. 4(C) are cross sections of a connector for a capacitor microphone, showing how the connector and capacitor microphone are assembled, in the related art; and

FIG. 5 is a cross section showing a part of another connector for the capacitor microphone, in the related art.

### DETAILED DESCRIPTION OF THE INVENTION

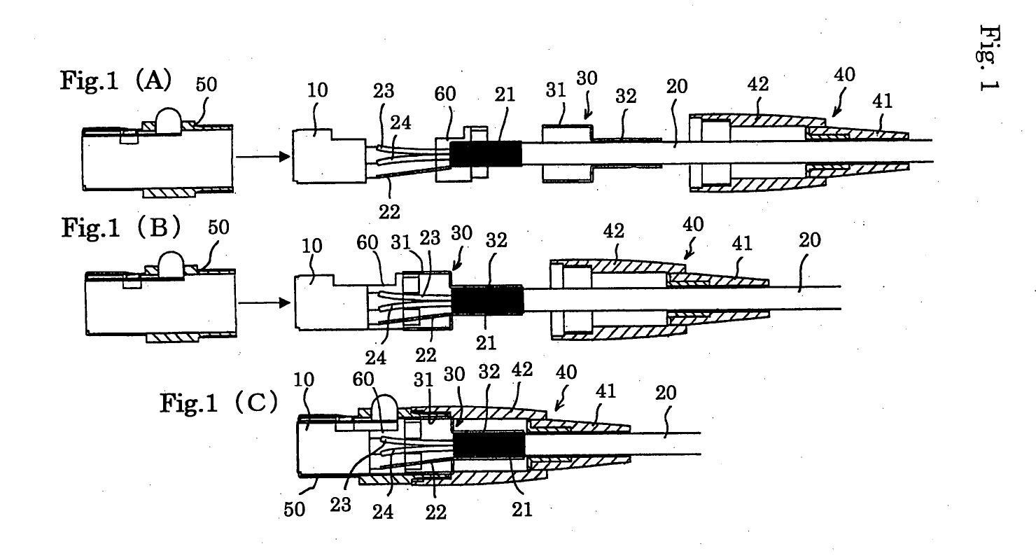

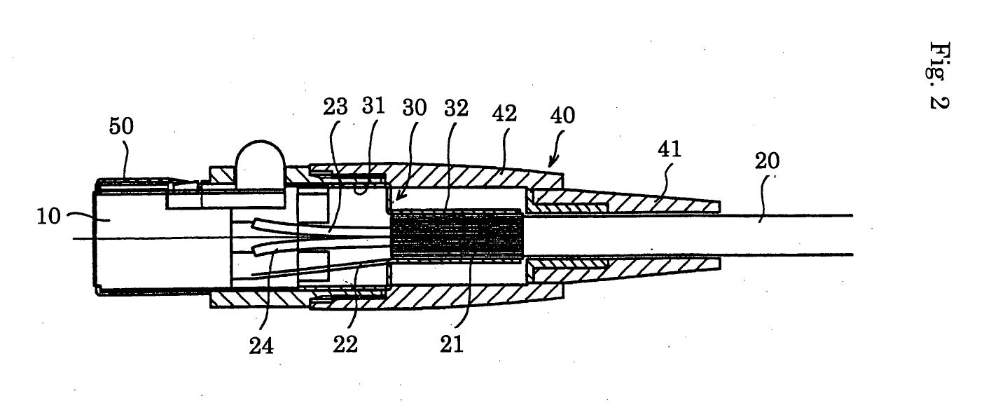

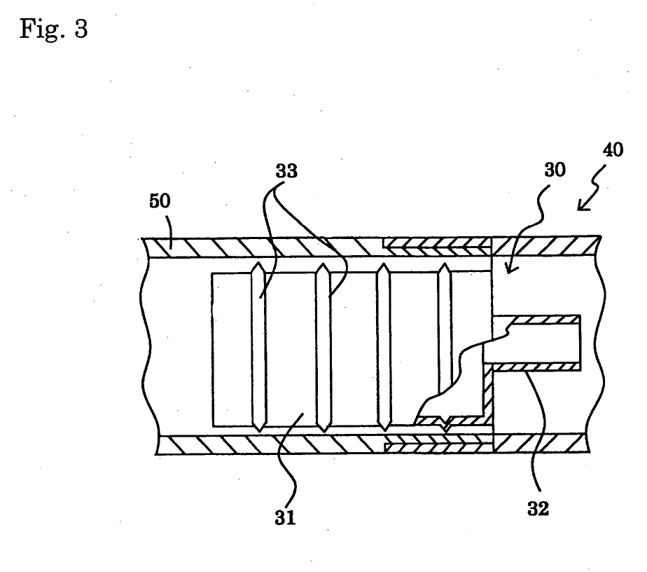

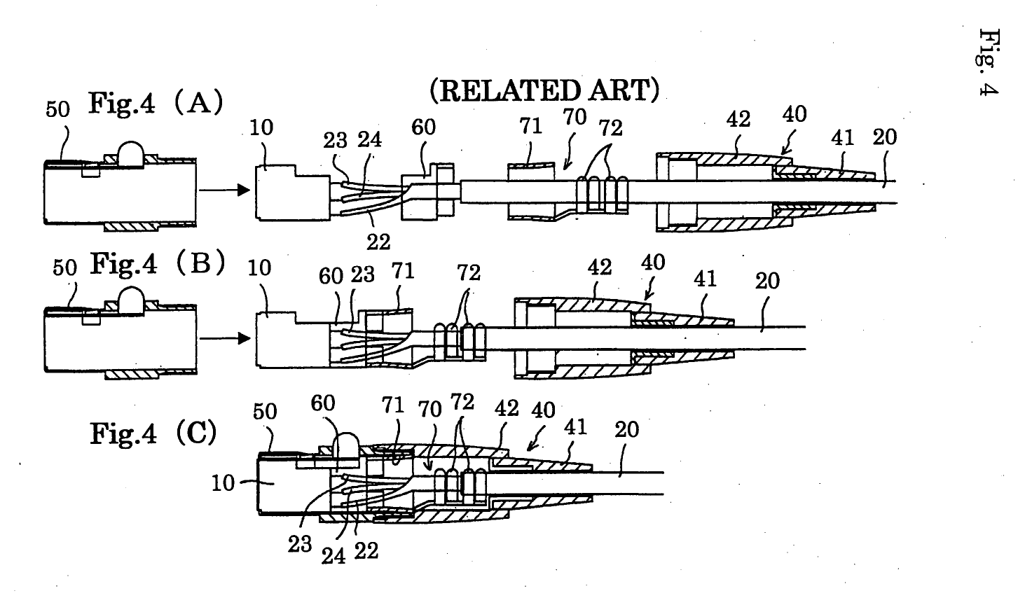

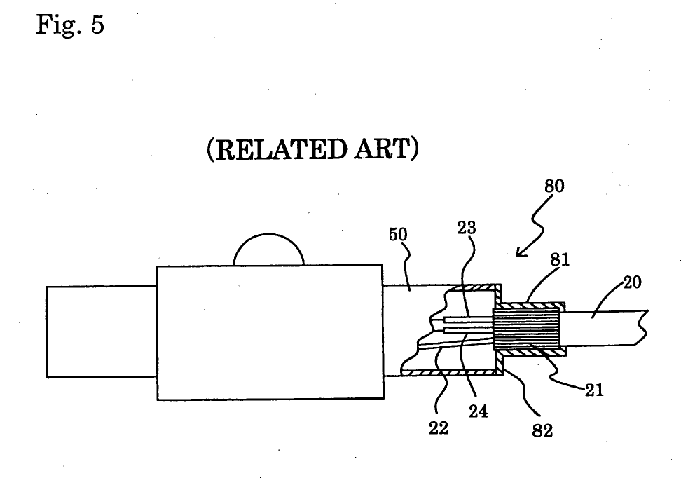

The invention will be described hereinafter with reference to FIG. 1(A), FIG. 1(B), FIG. 1(C), FIG. 2 and FIG. 3. The same or similar reference numbers are assigned to the same or similar parts shown in FIG. 4 and FIG. 5.

Referring to drawings related to the invention, a female connector 10 receives a male connector of a microphone or the like (not shown), so that they are electrically connected. The connector 10 is a so-called 3-in connector, and includes three pins to be engaged with the male connector, and terminal blocks which are integral with the three pins and extend outward from a rear end of the connector 10. Conductors 23 and 24 and a shielded wire 22 of a microphone cable 20 are respectively soldered to their corresponding terminal blocks. An insulating sleeve 60, a crimp 30 and a bush 40 are attached one after another around the microphone cable 20.

The insulating sleeve 60 covers a joint of one end of the microphone cable 20 and the connector 10, thereby protecting the joint against being short-circuited. The insulating sleeve 60 is as thick as the connector 10.

The crimp 30 has a thin cylindrical part 32, a thick cylindrical part 31, and a radially extending part between the cylindrical parts 32 and 31. Further, the crimp 30 functions as a shield, and is made of a shielding material, i.e., a conductive material. The thick cylindrical part 31 surrounds the joint of one end of the microphone cable 20 and the connector 10 with a space kept therebetween, and is substantially as thick as the insulating sleeve 60. The thin cylindrical part 32 is slightly thicker than the microphone cable 20. The shielded wire 22 surrounding the conductors 23 and 24 is outwardly folded, thereby extending over a sheath of the microphone cable 20, and functioning as a folded-back part 21. The thin cylindrical part 32 of the crimp 30 is attached around the folded-back part 21, and pressed. This enables the crimp 30 and the shielded wire 22 to be electrically connected, and makes the crimp 30 joined to the microphone case 20.

The bush 40 has a tapered end 41 which is slightly thicker than the microphone cable 20, and a cover 42 which is thicker than the tapered end 41 and can cover the crimp 30. The connector 10 is fitted into a cylindrical connector housing 50. The connector housing 50 is long enough to hold the connector 10, the insulating bush 60 and the thick cylindrical part 31 of the crimp 30, and is fitted via a rear end thereof into the front end of the bush 40.

FIG. 1(A) to FIG. 1(C) show how the microphone cable 20 and the connector 10 are assembled. Referring to FIG. 1(A), the conductors and shielded wire of the microphone cable 20 are soldered to their corresponding terminal blocks, so that the microphone cable 20 is connected to the connector 10. Before or after the soldering, the insulating sleeve 60 and crimp 30 are put on the microphone cable 20. The front end of the insulating sleeve 40 is brought into contact with the rear end of the connector 10. The front end of the thick cylindrical part 31 of the crimp 30 is fitted into the rear end of the insulating sleeve 60. At the same time, the thin cylindrical part 32 of the crimp 30 is fitted over the folded part 21 of the shield wire 22 of the microphone cable 20. Finally, the thin cylindrical part 32 is pressed, and the crimp 30 is joined to the microphone cable 20. Hence, the shielded wire 22 and the crimp 30 are made integral.

Referring to FIG. 1(C) and FIG. 2, the rear end of the connector housing 50, which extends over the connector 10, insulating sleeve 60 and thick cylindrical part 31, is fitted into the front end of the bush 40, so that the connector housing 50 and bush 40 are made integral.

As described above, the thick cylindrical part 31 extends over the joint of the microphone cable 20 and the connector 10. The thin cylindrical part 32 is fitted over the folded-back part 21 of the shielded wire 22, is pressed, and is electrically connected to the shielded wire 22 of the microphone cable 20. Further, the thick cylindrical part 31 is fitted into the connector housing 50, so that the shielded wire of the microphone cable 20 and the connector housing 50 are thoroughly and effectively shielded. The joint of the connector 10 and the microphone cable 20 are covered by the crimp 30 having the thin and thick cylindrical parts 32 and 31. The thin cylindrical part 32 is connected to the shielded wire 22 of the microphone cable 20. The thick cylindrical part 31 is fitted into the connector housing 50, and is electrically connected thereto. There is no non-shielded area at the joint of the connector 10 and the microphone cable 20.

The part radially extending between the thick cylindrical part 31 and the thin cylindrical part 32 effectively shields high frequency signals which get into the connector from an external source. This is effective in improving the shielding of the joint between the connector and the microphone cable.

The thin cylindrical part of the crimp 30 is crimped at the folded-back part 21 where the shield wire of the microphone connector 20 is folded back, so that the shielded wire 22 and the crimp 30 are reliably joined. This is effective in lowering electrical contact resistance, and shielding the joint more reliably.

The crimp 30 may be structured as shown in FIG. 3 in order to electrically connect the connector housing 50 and the microphone cable 20 more reliably. The crimp 30 has ribs 33 as well the thick and thin cylindrical parts 32 and 31. The ribs 33 are positioned on the peripheral surface of the thick cylindrical part 31, and are equally spaced along the central axis of the crimp 30. A maximum diameter of the crimp 30 including the ribs 33 is slightly larger than the inner diameter of the connector housing 50. When the thick cylindrical part 31 of the crimp 30 is fitted into the connector housing 50, the ribs 33 are pressed to the inner surface of the connector housing 50 due to the resilience of the thick cylindrical part 31.

The crimp 30 is brought into contact with the connector housing 50 only via the ribs 33, and contact pressure is concentrated on the ribs 33. This makes the connector housing 50 more conductive and promotes shielding of the joint of the connector 10 and the microphone cable 20.

The ribs 33 shown in FIG. 3 may have a triangular or semicircular cross section. The ribs 33 are equally spaced on the thick cylindrical part 31 of the crimp 30. Alternatively, the ribs 33 may be unequally spaced.

The foregoing describes that the connector is applied to the capacitor microphone. The connector is also usable in a variety of fields, but is very effective when used for the capacitor microphone which is susceptible to external high frequency signals.

What is claimed is:

1. A capacitor microphone connector comprising a crimp, wherein the crimp is made of a shielding material and includes a thick cylindrical part and a thin cylindrical part; the thin cylindrical part is fitted around a folded part of a shielded wire of a microphone cable, and the crimp is joined to the microphone cable; the thick cylindrical part extends over a joint of the connector and microphone cable; and the thick cylindrical part is fitted into a connector housing.

2. The capacitor microphone connector of claim 1, wherein a radially extending part is present between the thin and thick cylindrical parts of the crimp.

3. The capacitor microphone connector of claim 1, wherein an insulating sleeve covers the joint of the connector and the microphone cable, and the crimp is pressed on an outer surface of the insulating sleeve.

4. The capacitor microphone connector of claim 1, wherein a bush is fitted into the connector housing and covers all over the crimp.

5. The capacitor microphone connector of any one of claims 1 to 4, wherein the crimp further includes ribs extending over the thick cylindrical part, and the ribs are in pressure contact with an inner surface of the connector housing.

6. A method of shielding a connector and a capacitor microphone using a crimp made of a shielding material and having thick and thin cylindrical parts, the method comprising:
folding a shielded wire outward at one end of a microphone cable and making the folded-back part extend over the microphone cable;
attaching the thin cylindrical part of the crimp around the folded part of the shield wire, pressing the thick cylindrical part, making the microphone cable and connector electrically connectable;
covering the joint of the connector and microphone cable using the thick cylindrical part; and
fitting the thick cylindrical part into a connector housing.

7. The method of claim 6 further comprising covering the joint of the microphone cable and the connector using an insulating bush, and fitting the crimp over the insulating bush.
